(19) United States
(12) Patent Application Publication
(10) Pub. No.: US 2025/0310738 A1
(43) Pub. Date: Oct. 2, 2025

(54) MUSICAL PIECE INFORMATION PROVIDING SYSTEM, MUSICAL PIECE INFORMATION PROVIDING DEVICE, MUSICAL PIECE INFORMATION PROVIDING METHOD, AND STORAGE MEDIUM

(71) Applicant: HONDA MOTOR CO., LTD., TOKYO (JP)

(72) Inventors: Taiki YAMADA, TOKYO (JP); Kazuhide TAKAGI, TOKYO (JP); Daijiro MIYAMOTO, TOKYO (JP); Ryusuke TAMANAHA, TOKYO (JP)

(21) Appl. No.: 19/065,902

(22) Filed: Feb. 27, 2025

(30) Foreign Application Priority Data
Mar. 26, 2024 (JP) 2024-050005

(51) Int. Cl. H04W 4/46; G06F 3/16

(52) U.S. Cl. CPC H04W 4/46; G06F 3/162

(57) ABSTRACT

A musical piece information providing system is equipped with a generation unit for generating musical piece information indicative of musical piece played back by a musical piece playback device disposed in a first vehicle, and a providing unit for providing the musical piece information to a terminal device disposed in a second vehicle. The first vehicle and the second vehicle pass each other.

### CROSS-REFERENCE TO RELATED APPLICATIONS

This application is based upon and claims the benefit of priority from Japanese Patent Application No. 2024-050005 filed on Mar. 26, 2024, the contents of which are incorporated herein by reference.

### BACKGROUND OF THE INVENTION

### Field of the Invention

The present disclosure relates to a musical piece information providing system, a musical piece information providing device, a musical piece information providing method, and a storage medium.

### Description of the Related Art

JP 2001-343979 A discloses a music and information providing device that acquires, in a vehicle compartment, music data and information based on the categories according to user's preference in music and information, and provides the music and information.

### SUMMARY OF THE INVENTION

A technique that can provide musical piece information suitably has been long awaited.

An object of the present invention is to meet the aforementioned challenge.

A first aspect of the present disclosure is characterized by a musical piece information providing system including a generation unit configured to generate musical piece information indicative of a musical piece played back by a musical piece playback device disposed in a first vehicle, and a providing unit configured to provide the musical piece information to a terminal device disposed in a second vehicle, the first vehicle and the second vehicle passing each other.

A second aspect of the present disclosure is characterized by a musical piece information providing device including an acquisition unit configured to acquire musical piece information indicative of a musical piece played back by the musical piece playback device disposed in the first vehicle, and a transmission unit configured to transmit the musical piece information to a terminal device disposed in a second vehicle, the first vehicle and the second vehicle passing each other.

A third aspect of the present disclosure is characterized by a musical piece information providing method including the steps of a generating step of generating musical piece information indicative of a musical piece played back by a musical piece playback device disposed in a first vehicle, and a providing step of providing the musical piece information to a terminal device disposed in a second vehicle, the first vehicle and the second vehicle passing each other.

A fourth aspect of the present disclosure is characterized by a program for causing a computer to execute the musical piece information providing method according to the third aspect.

According to the present invention, it is possible to provide musical piece information suitably.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a diagram exemplifying a musical piece information providing system;

FIG. 2 is a diagram exemplifying musical piece information;

FIG. 3 is a diagram exemplifying a screen display of the musical piece information;

FIG. 4 is a flowchart illustrating an example of operation of a musical piece playback device disposed in a first vehicle;

FIG. 5 is a flowchart illustrating an example of operation of a musical piece playback device disposed in a second vehicle;

FIG. 6 is a diagram exemplifying a musical piece information providing system;

FIG. 7 is a diagram exemplifying a musical piece information providing system;

FIG. 8 is a flowchart illustrating an example of operation of a musical piece playback device disposed in the first vehicle;

FIG. 9 is a flowchart illustrating an example of the operation of a musical piece information providing device; and

FIG. 10 is a flowchart illustrating an example of operation of a musical piece playback device disposed in the second vehicle.

### DETAILED DESCRIPTION OF THE INVENTION

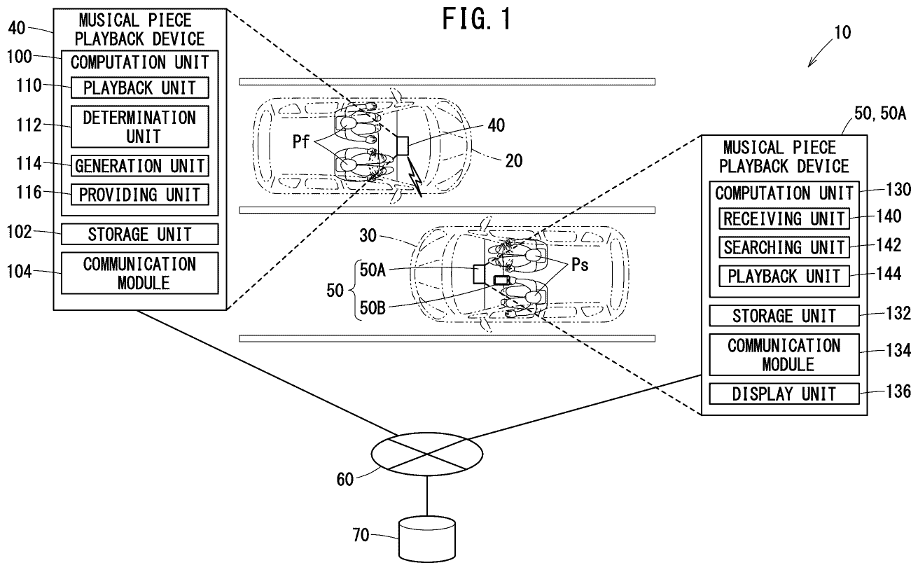

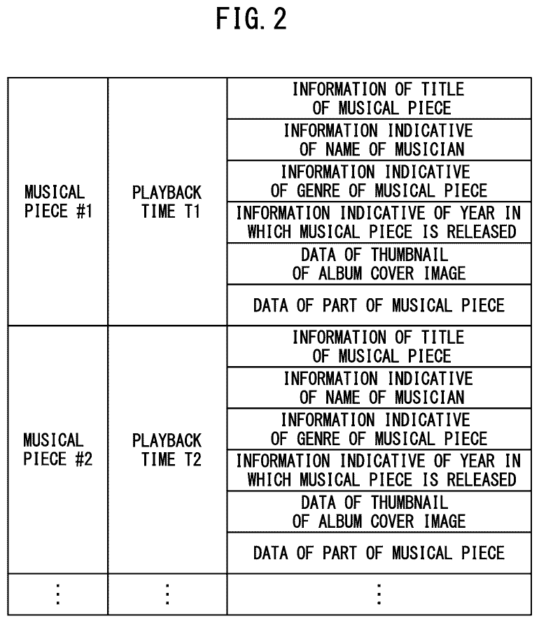

A musical piece information providing system according to an embodiment will be described with reference to the drawings. FIG. 1 is a diagram exemplifying a musical piece information providing system 10. In FIG. 1, a first vehicle 20 and a second vehicle 30 travel in opposite directions. When the first vehicle 20 and the second vehicle 30 pass each other, musical piece information is provided from a musical piece playback device 40 disposed in the first vehicle 20 to a terminal device 50 disposed in the second vehicle 30. The musical piece information will be described later with reference to FIG. 2. The musical piece information providing system 10 includes the musical piece playback device 40 disposed in the first vehicle 20 and the terminal device 50 disposed in the second vehicle 30.

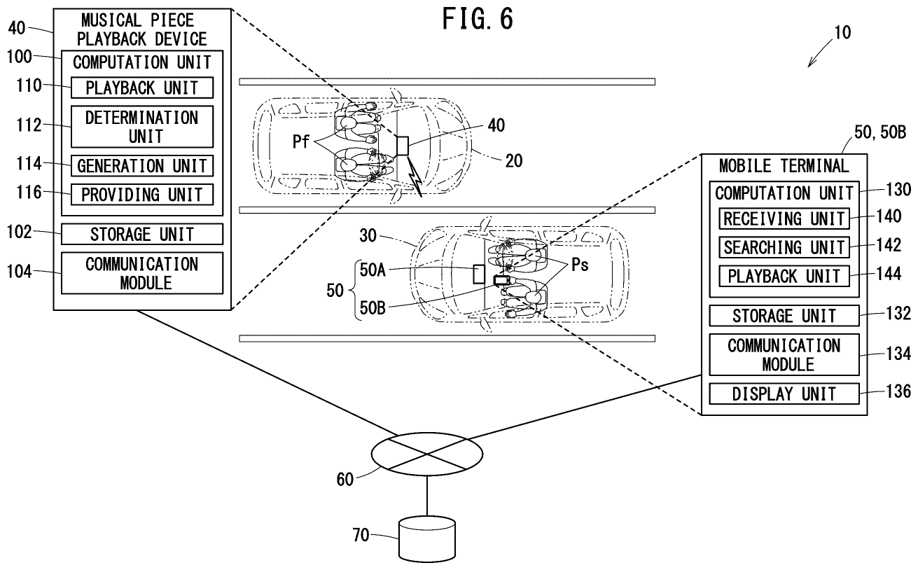

The terminal device 50 is a musical piece playback device 50A disposed in the second vehicle 30. In the present embodiment, the case where the terminal device 50 is the musical piece playback device 50A will be described as an example, but the terminal device 50 may be a mobile terminal 50B carried by at least one of vehicle occupants Ps of the second vehicle 30 as described later with reference to FIG. 6.

It is considered that the number of types of the musical piece playback device 50A is smaller than that of the mobile terminal 50B. Therefore, when the terminal device 50 is the musical piece playback device 50A, the cost for configuring the terminal device 50 can be suppressed to be low. Both the musical piece playback device 40 and the musical piece playback device 50A can be connected to a distribution server for musical pieces 70 via a wide area communication network 60.

The musical piece playback device 40 disposed in the first vehicle 20 includes a computation unit 100, a storage unit 102, and a communication module 104. The computation unit 100 is a computer, and includes a processor such as a CPU (Central Processing Unit), a GPU (Graphics Processing Unit), or the like. That is, the computation unit 100 includes a processing circuitry.

The storage unit 102 is a computer readable storage medium. The storage unit 102 includes a volatile memory such as a RAM (Random Access Memory) and a non-volatile memory such as a ROM (Read Only Memory) or a flash memory. The volatile memory is used as a working memory of the processor. The non-volatile memory stores therein programs executed by the processor, musical piece information, and data of musical pieces and the like. That is, the musical piece playback device 40 includes a program product of the programs executed by the processor.

By executing the program stored in the storage unit 102, the musical piece information is provided from the musical piece playback device 40 to the musical piece playback device 50A when the first vehicle 20 and the second vehicle 30 passes each other. The musical piece information is provided by communication between the musical piece playback device 40 and the musical piece playback device 50A.

In the musical piece playback device 40, the communication module 104 is used for communication with the musical piece playback device 50A. As a result, the first vehicle 20 and the second vehicle 30 can perform inter-vehicle communications. That is, the provision of the musical piece information is performed by inter-vehicle communications between the first vehicle 20 and the second vehicle 30. For example, wireless communication such as DSRC (Dedicated Short-Range Communications) (registered trademark) is used for inter-vehicle communications. Although the DSRC is used in the present embodiment, wireless communication by another method such as Bluetooth (registered trademark) may be used.

The communication module 104 can also be used for communication between the musical piece playback device 40 and the distribution server for musical pieces 70 via the wide area communication network 60.

The computation unit 100 includes a playback unit 110, a determination unit 112, a generation unit 114, and a providing unit 116. When the computation unit 100 executes a program stored in the storage unit 102, the playback unit 110, the determination unit 112, the generation unit 114, and the providing unit 116 are implemented.

At least a portion of the playback unit 110, the determination unit 112, the generation unit 114, and the providing unit 116 may be implemented by an integrated circuit such as an ASIC (Application Specific Integrated Circuit) or an FPGA (Field Programmable Gate Array), or an electronic circuit including a discrete device.

The playback unit 110 plays back a musical piece by using the data of the musical piece stored in the storage unit 102. The playback unit 110 may play back the musical piece by using the data of the musical piece distributed by the distribution server for musical pieces 70. The generation unit 114 generates musical piece information indicative of the musical piece played back by the playback unit 110 in association with the playback time of the musical piece and the playback order of the musical piece. The generation unit 114 stores the generated musical piece information in the storage unit 102.

The determination unit 112 detects an oncoming vehicle passing the first vehicle 20 (vehicle coming from the opposite direction) from the surrounding vehicles traveling around the first vehicle 20 by a camera or a sensor using a laser beam, or the like (none of which is shown) disposed in the first vehicle 20. The determination unit 112 determines the oncoming vehicle as the second vehicle 30. The determination unit 112 establishes the above-described inter-vehicle communications between the first vehicle 20 and the second vehicle 30 via the communication module 104.

The providing unit 116 acquires the musical piece information generated by the generation unit 114 from the storage unit 102. The musical piece information is information relating to musical piece played back by the playback unit 110 within a predetermined period before and including the timing when the first vehicle 20 and the second vehicle 30 pass each other. In accordance with such features, it is possible to provide timely musical piece information. Instead of the information on the musical pieces played back within the predetermined period before and including the timing, the information on the predetermined number of musical pieces played before and including the timing may be acquired.

The providing unit 116 provides the musical piece information generated by the generation unit 114 directly to the musical piece playback device 50A by the above-described inter-vehicle communications without providing a device for relaying the musical piece information. Therefore, the cost for configuring the musical piece information providing system 10 can be suppressed to be relatively low.

The musical piece playback device 50A disposed in the second vehicle 30 includes a computation unit 130, a storage unit 132, a communication module 134, and a display unit 136. The computation unit 130 is a computer, and includes a processor such as a CPU, a GPU, or the like. That is, the computation unit 130 includes a processing circuitry.

The storage unit 132 is a computer readable storage medium. The storage unit 132 includes a volatile memory such as a RAM or the like, and a non-volatile memory such as a ROM or a flash memory or the like. The volatile memory is used as a working memory of the processor. The non-volatile memory stores therein programs executed by the processor, and data of musical pieces and the like. That is, the musical piece playback device 50A includes a program product of the programs executed by the processor.

By executing the program stored in the storage unit 132, the data of the musical piece indicated by the musical piece information provided from the musical piece playback device 40 can be retrieved. As a result, the musical piece playback device 50A can indicate that the musical piece playback device 50A can play back the musical piece.

As described above, the provision of the musical piece information from the musical piece playback device 40 to the musical piece playback device 50A is performed by the inter-vehicle communications between the first vehicle 20 and the second vehicle 30. In the musical piece playback device 50A, the communication module 134 is used for communication with the musical piece playback device 40. The communication module 134 can also be used for communication between the musical piece playback device 50A and the distribution server for musical pieces 70 via the wide area communication network 60.

The display unit 136 is provided in the musical piece playback device 50A and displays various information and the like. The display unit 136 displays the musical piece information provided from the providing unit 116 of the musical piece playback device 40. When the data of the musical piece indicated by the musical piece information is stored in the storage unit 132, it is displayed that the musical piece can be played back by the musical piece playback device 50A.

The computation unit 130 includes a receiving unit 140, a searching unit 142, and a playback unit 144. When the computation unit 130 executes a program stored in the storage unit 132, the receiving unit 140, the searching unit 142, and the playback unit 144 are implemented. At least a portion of the receiving unit 140, the searching unit 142, and the playback unit 144 may be implemented by an integrated circuit such as an ASIC or an FPGA, or by an electronic circuitry including a discrete device.

The receiving unit 140 receives the musical piece information provided from the musical piece playback device 40 through the communication module 134 by the above-described inter-vehicle communications. The receiving unit 140 transmits the musical piece information to the display unit 136 to display the same.

The searching unit 142 searches the storage unit 132 for the data of the musical piece indicated by the musical piece information received by the receiving unit 140. When the data of the musical piece is stored in the storage unit 132, the searching unit 142 causes the display unit 136 to indicate that the musical piece can be played back by the musical piece playback device 50A.

The searching unit 142 may search for the data of the musical piece indicated by the musical piece information received by the receiving unit 140, from among the data of the musical pieces that can be distributed to the musical piece playback device 50A by the distribution server for musical pieces 70. When the data of the musical piece can be distributed, the searching unit 142 causes the display unit 136 to indicate that the musical piece can be played back by the musical piece playback device 50A. The vehicle occupants Ps of the second vehicle 30 can grasp the musical piece played back in the first vehicle 20. Thus, the vehicle occupants Ps of the second vehicle 30 may come to know the musical piece that is not be selected by the vehicle occupants Ps themselves, and consider listening to the musical piece.

The vehicle occupants Ps of the second vehicle 30 input to the musical piece playback device 50A the instruction for the playback of a part or the whole of a specific musical piece from among the musical pieces indicated by the musical piece information displayed on the display unit 136. In this case, the playback unit 144 plays back the part or the whole of the musical piece determined by the input instruction by using the data of the musical piece stored in the storage unit 132. The playback unit 144 may play back the part or the whole of the musical piece by using the data of the musical piece distributed by the distribution server for musical pieces 70.

In the case that the first vehicle 20 and the second vehicle 30 do not pass each other but the second vehicle 30 travels in the same direction as the first vehicle 20, it is possible that the musical piece information may be repeatedly provided from the first vehicle 20 to the second vehicle 30. That is, the destinations of the musical piece information provided by the first vehicle 20 are limited. It is also difficult for the second vehicle 30 to collect various pieces of musical piece information.

Further, the tendency of the musical piece preferred by the vehicle occupants Pf of the first vehicle 20 can be grasped by the vehicle occupants Ps of the second vehicle 30. Furthermore, it is also possible that the first vehicle 20 and the second vehicle 30 may be parked in the same rest facility or the like. In this case, trouble may occur between the vehicle occupants Pf of the first vehicle 20 and the vehicle occupants Ps of the second vehicle 30.

In the present embodiment, the second vehicle 30 is provided with musical piece information from the oncoming first vehicle 20 passing the second vehicle 30. The possibility that the first vehicle 20 and the second vehicle 30 pass each other again is low. Accordingly, the musical piece information may be provided to various destinations by the first vehicle 20. Further, after the second vehicle 30 and the first vehicle 20 pass each other, the second vehicle 30 may pass a plurality of other oncoming vehicles. Therefore, it is possible to collect various pieces of musical piece information in the second vehicle 30.

Since the traveling direction of the first vehicle 20 is different from the traveling direction of the second vehicle 30, it is unlikely that the first vehicle 20 and the second vehicle 30 will be parked in the same rest facility or the like. Therefore, it is possible to avoid trouble between the vehicle occupants Pf of the first vehicle 20 and the vehicle occupants Ps of the second vehicle 30.

FIG. 2 is a diagram exemplifying musical piece information. As described above, the musical piece information is stored in the storage unit 102 of the musical piece playback device 40 disposed in the first vehicle 20, in order of playback of the musical pieces. The musical piece information shown in FIG. 2 includes information of a list of musical pieces played back by the musical piece playback device 40. In the list, information of a musical piece #1 whose playback time T1 is the latest and information of a musical piece #2 whose playback time T2 is the second latest are arranged in chronological order. Although not shown in FIG. 2, information of musical pieces whose playback time is the third latest and subsequent ones may be arranged in the list in chronological order.

That is, in the list, the information of each musical piece is associated with the information of the playback time of each musical piece, and arranged in chronological order of the playback time. By including the list in the provided musical piece information, sufficient musical piece information can be provided in a timely manner.

As shown in FIG. 2, the musical piece information includes, as information of each musical piece, for example, information of a title of the musical piece, information indicative of a name of a musician of the musical piece, information indicative of a genre of the musical piece, and information indicative of a year in which the musical piece is released. In accordance with this feature, it is possible to provide easily understandable musical piece information from the first vehicle 20 to the second vehicle 30. The musical piece information may further include data of a thumbnail of album cover image and data of a part of each musical piece. More easily understandable musical piece information can be provided from the first vehicle 20 to the second vehicle 30. Also, the vehicle occupants Ps of the second vehicle 30 to which the musical piece information is provided can listen to a part of the musical piece, for trial listening.

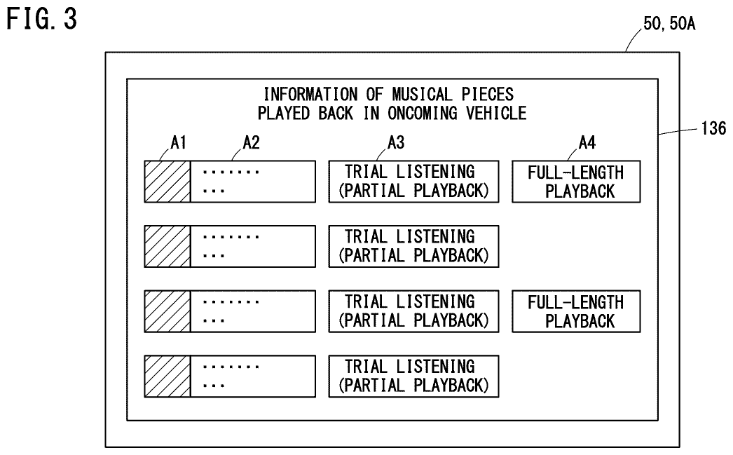

The musical piece information provided from the first vehicle 20 to the second vehicle 30 is displayed on the display unit 136 of the musical piece playback device 50A disposed in the second vehicle 30 as described above. FIG. 3 is a diagram exemplifying a screen display of the musical piece information. When the musical piece information includes data of thumbnails of the album cover images, the thumbnail is displayed in an area Al of the display unit 136. In an area A2, information on the title of the musical piece, information indicative of the name of the musician of the musical piece, information indicative of the genre of the musical piece, and information indicative of the year in which the musical piece was released are displayed.

In the case that the musical piece information includes data of a part of each of the musical pieces, an area A3 of the display unit 136 displays that the data of the part of the musical piece can be listened. When the vehicle occupants Ps of the second vehicle 30 tap the area A3, the playback unit 144 plays back a part of the musical piece. Thus, the vehicle occupants Ps can listen to the part of the musical piece. As a result, the vehicle occupants Ps may be interested in the musical piece.

As shown in FIG. 3, in the case that the data of the musical pieces is stored in the storage unit 132 among the musical pieces indicated by the musical piece information displayed on the display unit 136, or that the data of the musical pieces can be distributed by the distribution server for musical pieces 70, an area A4 of the display unit 136 display that the entire musical piece can be played back.

In the case that the vehicle occupants Ps of the second vehicle 30 become interested in any of musical pieces indicated by the musical piece information displayed on the display unit 136, it is possible that the vehicle occupants Ps may desire to play back the musical piece. In the case that the whole musical piece can be played back, the playback unit 144 plays back the musical piece by the vehicle occupants Ps tapping the area A4. The screen display shown in FIG. 3 allows easy identification of musical pieces that can be played back and easy playback of such musical pieces, which is highly convenient.

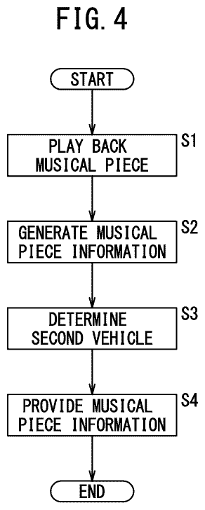

FIG. 4 is a flowchart illustrating an example of operation of the musical piece playback device 40 disposed in the first vehicle 20. FIG. 4 shows a processing sequence of a musical piece information providing method by the musical piece playback device 40. The present processing sequence is performed by the computation unit 100 of the musical piece playback device 40 executing a program stored in the storage unit 102.

When the present processing sequence is started, in step S1, the playback unit 110 plays back the musical piece by using the data of the musical piece stored in the storage unit 102 or the data of the musical piece distributed by the distribution server for musical pieces 70. In step S2, the generation unit 114 generates musical piece information indicative of the musical piece played back in step S1.

In step S3, the determination unit 112 determines the oncoming second vehicle 30 that passes the first vehicle 20 by using a sensor. In step S4, the providing unit 116 provides the musical piece information generated in step S2 to the musical piece playback device 50A. When the processing of step $4 is completed, this processing sequence is terminated.

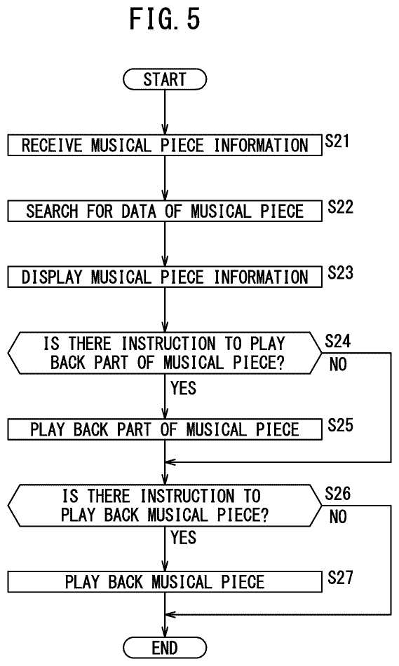

FIG. 5 is a flowchart illustrating an example of operation of the musical piece playback device 50A disposed in the second vehicle 30. FIG. 5 shows a processing sequence of a musical piece playback method by the musical piece playback device 50A. The present processing sequence is performed by the computation unit 130 of the musical piece playback device 50A executing a program stored in the storage unit 132.

When the present processing sequence is started, in step S21, the receiving unit 140 receives the musical piece information provided from the musical piece playback device 40 in the processing sequence shown in FIG. 4. In step S22, the searching unit 142 searches the storage unit 132 for the data of the musical piece indicated by the musical piece information received in step S21. The searching unit 142 may search for the data of the musical piece indicated by the musical piece information received in step S21 from among the data of the musical piece that can be distributed to the musical piece playback device 50A by the distribution server for musical pieces 70.

In step S23, the searching unit 142 causes the display unit 136 to display that the musical piece can be played back by the musical piece playback device 50A, together with the musical piece information received in step S21. In step S24, the playback unit 144 determines whether or not there is an instruction to play back a part of a specific musical piece from among the musical pieces indicated by the musical piece information displayed on the display unit 136. When the area A3 of the display unit 136 of the musical piece playback device 50A shown in FIG. 3 is tapped by any of the vehicle occupants Ps of the second vehicle 30, it is determined that there is an instruction to play back a part of the specific musical piece, and the result of the decision is YES in step S24.

If YES is determined in step S24, the processing sequence proceeds to step S25. If NO is determined in step S24, the processing sequence proceeds to step S26. In step S25, the playback unit 144 plays back a part of the target musical piece instructed in step S24.

In step S26, the playback unit 144 determines whether or not there is an instruction to play back a specific musical piece from among the musical pieces indicated by the musical piece information displayed on the display unit 136. When the area A4 of the display unit 136 of the musical piece playback device 50A shown in FIG. 3 is tapped by any of the vehicle occupants Ps of the second vehicle 30, it is determined that there is an instruction to play back the specific musical piece, and the result of the decision is YES in step S26.

If YES is determined in step S26, the processing sequence proceeds to step S27. If NO is determined in step S26, the present processing sequence comes to an end. In step S27, the playback unit 144 plays back the target musical piece instructed in step S26. The whole musical piece is played back. When the processing of step S27 is completed, the present processing sequence is terminated.

The above-described embodiment may be modified in the following manner. In exemplary modifications described below, descriptions that overlap or are duplicative of those in the embodiment will be omitted.

### Modification 1

In the above-described embodiment, the musical piece information is provided from the musical piece playback device 40 mounted in the first vehicle 20 to the terminal device 50 mounted in the second vehicle 30. The terminal device 50 is the musical piece playback device 50A mounted in the second vehicle 30, but the present invention is not limited to this feature. In a modification 1, a terminal device 50 is a mobile terminal 50B held by at least one of vehicle occupants Ps of a second vehicle 30. It is considered that the penetration rate of the mobile terminal 50B is higher than that of the musical piece playback device 50A. Since the musical piece information can be grasped via the mobile terminal 50B having a high penetration rate, convenience is enhanced.

The provision of the musical piece information from the musical piece playback device 40 to the mobile terminal 50B is performed by ad hoc communication. In the ad hoc communication, DSRC is used as in the inter-vehicle communications. Although the DSRC is used in the present modification, wireless communication by another method such as Bluetooth (registered trademark) may be used.

FIG. 6 is a diagram exemplifying a musical piece information providing system 10. The musical piece information providing system 10 shown in FIG. 6 is different from the musical piece information providing system 10 shown in FIG. 1 in that a mobile terminal 50B is used as a terminal device 50 to which musical piece information is provided, but the other configurations are the same. The configuration of the mobile terminal 50B shown in FIG. 6 is also the same as that of a musical piece playback device 50A shown in FIG. 1. The operation of the musical piece information providing system 10 in the modification 1 is the same as that of the musical piece information providing system 10 in the above-described embodiment, and therefore, the description of the operation is omitted.

### Modification 2

In the above-described embodiment, the musical piece information is directly provided from the musical piece playback device 40 disposed in the first vehicle 20 to the musical piece playback device 50A disposed in the second vehicle 30, but the present invention is not limited to this feature. In the modification 2, the musical piece information provided from a musical piece playback device 40 is received by a musical piece playback device 50A via a wide area communication network 60 and a musical piece information providing device. That is, the musical piece information providing device is a device for relaying the musical piece information provided from the musical piece playback device 40 to the musical piece playback device 50A.

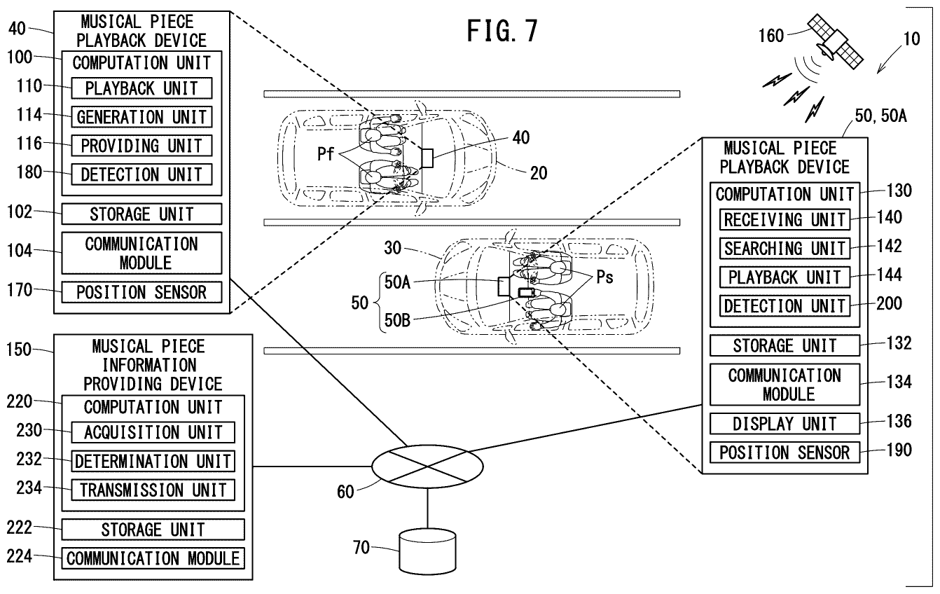

FIG. 7 is a diagram exemplifying a musical piece information providing system 10. The musical piece information providing system 10 includes a musical piece playback device 40, a musical piece playback device 50A, and a musical piece information providing device 150. The musical piece playback device 40 is connected to the musical piece information providing device 150 via the wide area communication network 60. The musical piece playback device 50A is also connected to the musical piece information providing device 150 via the wide area communication network 60.

Unlike the musical piece playback device 40 in the above-described embodiment, the musical piece playback device 40 disposed in a first vehicle 20 does not determine an oncoming second vehicle 30 that passes the first vehicle 20. Therefore, as shown in FIG. 7, the musical piece playback device 40 does not include the determination unit 112 shown in FIG. 1. The oncoming second vehicle 30 that passes the first vehicle 20 is determined by the musical piece information providing device 150 based on a positioning signal from a positioning satellite 160 as described later.

The musical piece playback device 40 further includes a position sensor 170. The position sensor 170 receives a positioning signal from the positioning satellite 160. The computation unit 100 of the musical piece playback device 40 further includes a detection unit 180. The detection unit 180 detects the position and time of the first vehicle 20 when the positioning signal is received, based on the positioning signal received by the position sensor 170. The detection unit 180 cyclically notifies the musical piece information providing device 150 of the information relating to the detected position and time of the first vehicle 20 via a communication module 104 and the wide area communication network 60.

The providing unit 116 cyclically provides the musical piece information generated by a generation unit 114 to the musical piece information providing device 150 via the communication module 104 and the wide area communication network 60. Information relating to musical pieces played back within a predetermined period before and including a cycle timing in which the musical piece information is provided, is provided as the musical piece information. Instead of the information relating to the musical pieces played back within the predetermined period before and including the cycle timing, the information on a predetermined number of musical pieces played back before and including the timing may be acquired.

The musical piece playback device 50A further includes a position sensor 190. The position sensor 190 receives the positioning signal from the positioning satellite 160. The computation unit 130 of the musical piece playback device 50A further includes a detection unit 200. The detection unit 200 detects the position and time of the second vehicle 30 when the positioning signal is received, based on the positioning signal received by the position sensor 190. The detection unit 200 cyclically notifies the musical piece information providing device 150 of the information relating to the detected position and time of the second vehicle 30 via a communication module 134 and the wide area communication network 60.

The receiving unit 140 receives the musical piece information provided from the musical piece playback device 40 to the musical piece information providing device 150, from the musical piece information providing device 150 via the wide area communication network 60 and the communication module 134.

The musical piece information providing device 150 includes a computation unit 220, a storage unit 222, and a communication module 224. The computation unit 220 is a computer, and includes a processor such as a CPU, a GPU, or the like. That is, the computation unit 220 includes a processing circuitry.

The storage unit 222 is a computer readable storage medium. The storage unit 222 includes a volatile memory such as a RAM or the like, and a non-volatile memory such as a ROM or a flash memory or the like. The volatile memory is used as a working memory of the processor. The non-volatile memory stores therein programs executed by the processor, musical piece information, and road data and the like. That is, the musical piece information providing device 150 includes a program product of the programs executed by the processor.

By executing the program stored in the storage unit 222, the oncoming second vehicle 30 that passes the first vehicle 20 can be determined. The musical piece information provided from the musical piece playback device 40 disposed in the first vehicle 20 can be transmitted to the second vehicle 30.

The communication module 224 is used for communication between the musical piece information providing device 150 and the first vehicle 20. The communication module 224 is also used for communication between the musical piece information providing device 150 and the second vehicle 30. The musical piece information providing device 150 acquires musical piece information from the musical piece playback device 40 disposed in the first vehicle 20 through the wide area communication network 60 and the communication module 224. The musical piece information providing device 150 transmits the acquired musical piece information to the musical piece playback device 50A disposed in the second vehicle 30 via the wide area communication network 60 and the communication module 224.

The musical piece information providing device 150 acquires the position information notified from the musical piece playback device 40 and the musical piece playback device 50A, through the wide area communication network 60 and the communication module 224.

The computation unit 220 includes an acquisition unit 230, a determination unit 232, and a transmission unit 234. When the computation unit 220 executes the program stored in the storage unit 222, the acquisition unit 230, the determination unit 232, and the transmission unit 234 are implemented. At least a portion of the acquisition unit 230, the determination unit 232, and the transmission unit 234 may be implemented by an integrated circuit such as an ASIC or an FPGA, or by an electronic circuitry including a discrete device.

The acquisition unit 230 cyclically acquires the position information of the first vehicle 20 from the musical piece playback device 40 via the communication module 224. The acquisition unit 230 cyclically acquires the musical piece information provided from the providing unit 116 of the musical piece playback device 40, from the musical piece playback device 40 via the communication module 224. The acquisition unit 230 stores the acquired musical piece information in the storage unit 222. The acquisition unit 230 cyclically acquires the position information of the second vehicle 30 from the musical piece playback device 50A via the communication module 224.

The determination unit 232 detects that the second vehicle 30 and the first vehicle 20 pass each other on the basis of the position information of the first vehicle 20 acquired by the acquisition unit 230, the position information of the second vehicle 30 acquired by the acquisition unit 230, and the road data stored in the storage unit 222. In this way, the determination unit 232 determines the second vehicle 30.

The transmission unit 234 acquires, from the storage unit 222, musical piece information satisfying a predetermined condition, among the musical piece information acquired by the acquisition unit 230 before and including the timing when the first vehicle 20 and the second vehicle 30 pass each other. The musical piece information satisfying the predetermined condition is information relating to musical pieces played back by the musical piece playback device 40 within a predetermined period before and including the timing. The transmission unit 234 transmits the acquired musical piece information to the receiving unit 140 of the musical piece playback device 50A via the communication module 224.

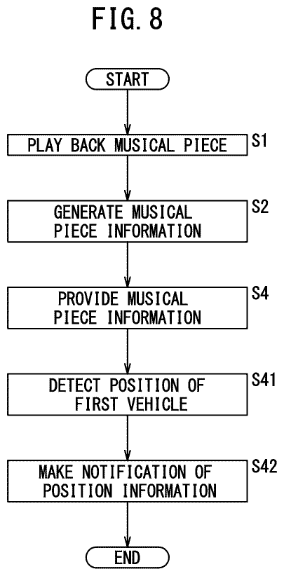

FIG. 8 is a flowchart illustrating an example of operation of the musical piece playback device 40 disposed in the first vehicle 20. FIG. 8 shows a processing sequence of a musical piece information providing method by the musical piece playback device 40. The present processing sequence is performed by the computation unit 100 of the musical piece playback device 40 executing a program stored in the storage unit 102. The same reference numerals are assigned to the same steps as those described above with reference to FIG. 4, and the detailed description thereof is omitted as appropriate.

When the processing of step S2 is completed, the present processing sequence proceeds to step S4. In step S4, the providing unit 116 provides the musical piece information generated in step S2 to the musical piece information providing device 150. When the processing of step S4 is completed, the present processing sequence proceeds to step S41. In step S41, the detection unit 180 detects the position of the first vehicle 20. In step S42, the detection unit 180 notifies the musical piece information providing device 150 of the position information of the first vehicle 20 detected in step S41. When the processing of step S42 is completed, the present processing sequence is terminated.

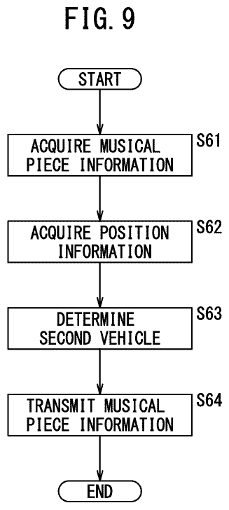

FIG. 9 is a flowchart illustrating an example of the operation of the musical piece information providing device 150. FIG. 9 shows a processing sequence of a musical piece information providing method by the musical piece information providing device 150. The present processing sequence is performed by the computation unit 220 of the musical piece information providing device 150 executing a program stored in the storage unit 222.

When the present processing sequence is started, in step S61, the acquisition unit 230 acquires the musical piece information provided from the musical piece playback device 40. In step S62, the acquisition unit 230 acquires the position information of the first vehicle 20 from the musical piece playback device 40. The acquisition unit 230 acquires the position information of the second vehicle 30 from the musical piece playback device 50A.

In step S63, the determination unit 232 determines the second vehicle 30 that passes the first vehicle 20 based on the position information of the first vehicle 20 and the position information of the second vehicle 30 acquired in step S62. In step S64, the transmission unit 234 transmits the musical piece information acquired in step S61 to the musical piece playback device 50A disposed in the second vehicle 30 determined in step S63. When the processing of step S64 is completed, the present processing sequence is terminated.

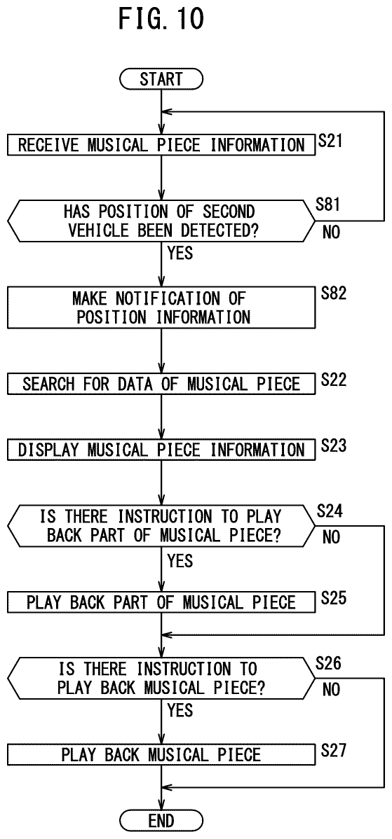

FIG. 10 is a flowchart illustrating an example of operation of the musical piece playback device 50A disposed in the second vehicle 30. FIG. 10 shows a processing sequence of a musical piece playback method by the musical piece playback device 50A. The present processing sequence is performed by the computation unit 130 of the musical piece playback device 50A executing a program stored in the storage unit 132. The same reference numerals are assigned to the same steps as those described above with reference to FIG. 5, and the detailed description thereof is omitted as appropriate.

When the present processing sequence is started, in step S21, the receiving unit 140 receives the musical piece information provided from the musical piece playback device 40 in the processing sequence shown in FIG. 8, from the musical piece information providing device 150. In step S81, the detection unit 200 determines whether or not the position of the second vehicle 30 has been detected. If YES is determined in step S81, the present processing sequence proceeds to step S82. If NO is determined in step S81, the present processing sequence returns to step S21. In step S82, the detection unit 200 notifies the musical piece information providing device 150 of the position information of the second vehicle 30. When the processing of step S82 is completed, the present processing sequence proceeds to step S22.

In the above-described embodiment, a sensor disposed in the first vehicle 20 is used for determining the second vehicle 30. Therefore, the determination performance of the second vehicle 30 depends on the performance of each of the sensors. In the modification 2, since the positioning signal from the positioning satellite 160 is used for determining the second vehicle 30, the second vehicle 30 is determined with a certain accuracy without depending on the performance of the sensor described above.

It is generally considered that the computational performance of the musical piece information providing device 150 is higher than the computational performance of the musical piece playback device 40. Therefore, the determination of the second vehicle 30 passing the first vehicle 20 can be performed with high accuracy. As a result, the provision of the musical piece information from the musical piece playback device 40 disposed in the first vehicle 20 to the musical piece playback device 50A disposed in the second vehicle 30 can be performed with high accuracy.

In the modification 2, the acquisition unit 230 acquires the position information of the second vehicle 30 from the musical piece playback device 50A disposed in the second vehicle 30, but the present invention is not limited to this feature. In the musical piece playback device 40 disposed in the first vehicle 20, the second vehicle 30 may be determined by using a sensor. The position of the second vehicle 30 can be calculated by the musical piece playback device 40 on the basis of the result of the determination of the second vehicle 30 and the position information of the first vehicle 20. In this case, the acquisition unit 230 acquires the position information of the second vehicle 30 from the musical piece playback device 40.

The following supplementary notes are further disclosed in relation to the above-described embodiment.

### Supplementary Note 1

The musical piece information providing system (10) according to the present disclosure includes the generation unit (114) configured to generate musical piece information indicative of musical piece played back by the musical piece playback device (40) disposed in the first vehicle (20), and the providing unit (116) configured to provide the musical piece information to the terminal device (50) disposed in the second vehicle (30), the first vehicle and the second vehicle passing each other. In accordance with such a configuration, it is possible to provide the musical piece information while avoiding trouble. In other words, the musical piece information can be provided suitably.

### Supplementary Note 2

The musical piece information providing system according to Supplementary Note 1 may further include the musical piece information providing device (150) configured to communicate with the first vehicle and communicate with the second vehicle, wherein the musical piece information providing device may be configured to acquire the musical piece information from the first vehicle and to transmit the musical piece information that has been acquired, to the second vehicle. In accordance with such a configuration, the provision of the musical piece information can be performed with high accuracy.

### Supplementary Note 3

In the musical piece information providing system according to Supplementary Note 1, the first vehicle and the second vehicle may be configured to perform communications with each other, and the musical piece information may be directly provided from the providing unit disposed in the first vehicle to the terminal device disposed in the second vehicle. In accordance with such a configuration, the cost for configuring the musical piece information providing system can be suppressed to be relatively low.

### Supplementary Note 4

In the musical piece information providing system according to any one of Supplementary Notes 1 to 3, the terminal device may be the musical piece playback device (50A) disposed in the second vehicle. In accordance with such a configuration, the cost for configuring the terminal device 50 can be suppressed to be low.

### Supplementary Note 5

In the musical piece information providing system according to any one of Supplementary Notes 1 to 3, the terminal device may be the mobile terminal (50B) carried by the vehicle occupant (Ps) of the second vehicle. In accordance with such a configuration, since the musical piece information can be grasped via the mobile terminal, convenience is enhanced.

### Supplementary Note 6

In the musical piece information providing system according to any one of Supplementary Notes 1 to 3, the musical piece information may be information relating to the musical piece played back by the musical piece playback device within the predetermined period before and including the timing when the first vehicle and the second vehicle pass each other. In accordance with such a configuration, it is possible to provide timely musical piece information.

### Supplementary Note 7

In the musical piece information providing system according to any one of Supplementary Notes 1 to 3, the musical piece information may include information of the list of the musical pieces played back by the musical piece playback device. In accordance with such a configuration, sufficient musical piece information can be provided.

### Supplementary Note 8

In the musical piece information providing system according to any one of Supplementary Notes 1 to 3, the musical piece information may include information of the title of the musical piece. In accordance with such a configuration, it is possible to provide easily understandable musical piece information.

### Supplementary Note 9

In the musical piece information providing system according to Supplementary Note 8, the musical piece information may further include data of a part of the musical piece. In accordance with such a configuration, the vehicle occupant of the second vehicle to which the musical piece information is provided can listen to a part of the musical piece, for trial listening.

### Supplementary Note 10

The musical piece information providing system according to any one of Supplementary Notes 1 to 3 may further include the display unit (136) configured to, in the case data of the musical piece indicated by the musical piece information that has been provided by the providing unit is stored in the musical piece playback device disposed in the second vehicle as the terminal device, indicate that the musical piece can be played back by the musical piece playback device disposed in the second vehicle. In accordance with such a configuration, easy identification of musical pieces that can be played back and easy playback of such musical pieces are possible, which is highly convenient.

### Supplementary Note 11

The musical piece information providing system according to any one of Supplementary Notes 1 to 3 may further include the display unit configured to, in the case that data of the musical piece indicated by the musical piece information that has been provided by the providing unit is configured to be distributed to the musical piece playback device disposed in the second vehicle as the terminal device, indicate that the musical piece can be played back by the musical piece playback device disposed in the second vehicle. In accordance with such a configuration, easy identification of musical pieces that can be played back and easy playback of such musical pieces are possible, which is highly convenient.

### Supplementary Note 12

The musical piece information providing device according to the present disclosure includes the acquisition unit (230) configured to acquire musical piece information indicative of the musical piece played back by the musical piece playback device disposed in the first vehicle, and the transmission unit (234) configured to transmit the musical piece information to the terminal device disposed in the second vehicle, the first vehicle and the second vehicle passing each other. In accordance with such a configuration, it is possible to provide the musical piece information while avoiding trouble. In other words, the musical piece information can be provided suitably.

### Supplementary Note 13

The musical piece information providing method according to the present disclosure includes the steps of the generating step of generating musical piece information indicative of the musical piece played back by the musical piece playback device disposed in the first vehicle, and the providing step of providing the musical piece information to the terminal device disposed in the second vehicle, the first vehicle and the second vehicle passing each other. In accordance with such a configuration, it is possible to provide the musical piece information while avoiding trouble. In other words, the musical piece information can be provided suitably.

### Supplementary Note 14

The program of the present disclosure is the program for causing the computer to execute the musical piece information providing method according to Supplementary Note 13. In accordance with such a configuration, it is possible to provide the musical piece information while avoiding trouble. In other words, the musical piece information can be provided suitably.

While the present disclosure has been described in detail, the present disclosure is not limited to the individual embodiments described above. Within a range that does not depart from the essence and gist of the present disclosure, or within a range that does not depart from the gist and essence of the present disclosure derived from the content described in the claims and equivalents thereof, various additions, substitutions, changes, partial deletions, or the like can be made to such embodiments. These embodiments may also be implemented in combination. For example, in the embodiments described above, the order of each of the operations and the order of each of the processes are shown as examples, and the present invention is not limited to such operations and processes. The same applies to the case where numerical values or mathematical expressions are used in the description of the above-described embodiments.

1. A musical piece information providing system comprising one or more processors that execute computer-executable instructions stored in a memory,
wherein the one or more processors execute the computer-executable instructions to cause the musical piece information providing system to:
generate musical piece information indicative of a musical piece played back by a musical piece playback device disposed in a first vehicle; and
provide the musical piece information to a terminal device disposed in a second vehicle, the first vehicle and the second vehicle passing each other.

2. The musical piece information providing system according to claim 1, wherein the one or more processors cause the musical piece information providing system to acquire the musical piece information from the first vehicle and to transmit the musical piece information that has been acquired, to the second vehicle.

3. The musical piece information providing system according to claim 1,
wherein the first vehicle and the second vehicle are configured to perform communications with each other, and
the musical piece information is directly provided from the first vehicle to the terminal device disposed in the second vehicle.

4. The musical piece information providing system according to claim 1, wherein the terminal device is a musical piece playback device disposed in the second vehicle.

5. The musical piece information providing system according to claim 1, wherein the terminal device is a mobile terminal carried by a vehicle occupant of the second vehicle.

6. The musical piece information providing system according to claim 1, wherein the musical piece information is information relating to the musical piece played back by the musical piece playback device within a predetermined period before and including a timing when the first vehicle and the second vehicle pass each other.

7. The musical piece information providing system according to claim 1, wherein the musical piece information includes information of a list of the musical pieces played back by the musical piece playback device.

8. The musical piece information providing system according to claim 1, wherein the musical piece information includes information of a title of the musical piece.

9. The musical piece information providing system according to claim 8, wherein the musical piece information further includes data of a part of the musical piece.

10. The musical piece information providing system according to claim 1,
wherein the one or more processors execute the computer-executable instructions to further cause the musical piece information providing system to:
in a case that data of the musical piece indicated by the musical piece information that has been provided is stored in a musical piece playback device disposed in the second vehicle as the terminal device, indicate that the musical piece can be played back by the musical piece playback device disposed in the second vehicle.

11. The musical piece information providing system according to claim 1,
wherein the one or more processors execute the computer-executable instructions to further cause the musical piece information providing system to:
in a case that data of the musical piece indicated by the musical piece information that has been provided is configured to be distributed to a musical piece playback device disposed in the second vehicle as the terminal device, indicate that the musical piece can be played back by the musical piece playback device disposed in the second vehicle.

12. A musical piece information providing device comprising one or more processors that execute computer-executable instructions stored in a memory,
wherein the one or more processors execute the computer-executable instructions to cause the musical piece information providing device to:
acquire musical piece information indicative of a musical piece played back by a musical piece playback device disposed in a first vehicle; and
transmit the musical piece information to a terminal device disposed in a second vehicle, the first vehicle and the second vehicle passing each other.

13. A musical piece information providing method comprising:
generating musical piece information indicative of a musical piece played back by a musical piece playback device disposed in a first vehicle; and
providing the musical piece information to a terminal device disposed in a second vehicle, the first vehicle and the second vehicle passing each other.

14. A non-transitory computer-readable storage medium storing a program for causing a computer to execute the musical piece information providing method according to claim 13.
